(19) United States
(12) Patent Application Publication
(10) Pub. No.: US 2006/0257610 A1
(43) Pub. Date: Nov. 16, 2006

(54) Label blank

(76) Inventor: Paul Ian Brett, Great Dunmow, Essex (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/548,152

(22) PCT Filed: Mar. 2, 2004
(86) PCT No.: PCT/GB04/00857

§ 371 Date: May 8, 2006

(30) Foreign Application Priority Data
Mar. 4, 2003 (GB) 0304843.6

(51) Int. Cl. B32B 33/00; B32B 3/10; B32B 9/00

(52) U.S. Cl. 428/42.3; 428/137; 428/40.1

(57) ABSTRACT

A blank for forming into a label for carrying information, which blank comprises a self adhesive sheet (10) having delineated thereon at least four distinct areas (13,14,15,16) in a symmetrical arrangement with a strippable backing layer (11) on the self-adhesive face of the blank. Each area has an upper surface on which data can be printed, and there are fold lines (18,19,20,21) between adjacent areas. On stripping the printed blank from the backing layer and folding the blank about a fold line coincident with the axis of symmetry, the self-adhesive faces are brought into contact with each other thereby forming a label having half as many regions as there were areas in the blank. These regions are separated by overlying fold lines, about which the regions may be relatively folded to conceal printed information thereon.

The present invention relates to a self-adhesive blank for printing labels, and in particular to a blank for forming a printed label in which at least part of the information carried thereon is protected.

Self-adhesive labels and the blanks for forming them are well known and take a variety of forms. Such items are usually provided on a peelable backing layer and may be printed or otherwise imparted with suitable information. In general the purpose of the adhesive is to affix the label to an item that is to be labelled, the label being stripped from the backing sheet and adhered to the item.

It is an object of the present invention to provide a label which may be printed when adhered to a backing layer but may be removed therefrom and assembled into a tag which is attached to an item. Unfortunately, whilst some of such tags do exist it has not yet proved possible to provide one which may be continuously printed by normal printing machines and therefore their use is limited to particular situations in which the convenience and cost-efficiency of continuous printing and collating is not essential.

In contrast, the present invention stems from the appreciation that a continuously printable self-adhesive blank can be used to form a complicated non-adhesive label such that the convenience of continuous printing can be applied to a situation where a more sophisticated label or tag construction is necessary.

Further, printed labels, unless subjected to highly expensive printing processes, can be subject to degradation of the print quality. In other words, normal printing techniques such as laser printing form a printed image that may be subject to wear if not suitably protected. There are already in existence complicated methods of protecting such printing, for example by laminating with clear plastic. However, this can add to the cost and complexity of producing such a label. In contrast, the present invention provides a mechanism by which the effective life of normal printed information can be enhanced without significant cost increase.

According to the present invention there is provided a blank for forming into a label for carrying information, which blank comprises a self-adhesive sheet having delineated thereon at least four distinct areas in a symmetrical arrangement with a strippable backing layer on the self-adhesive face of the blank, each area having an upper surface on which data can be mechanically printed and there being fold lines between adjacent areas whereby on stripping the printed blank from the backing layer and folding the blank about a fold line coincident with the axis of symmetry the self-adhesive faces are brought into contact with each other thereby forming a label having half as many regions as there were areas in the blank, those regions being separated by overlying fold lines about which the regions may be relatively folded to conceal printed information thereon.

The blank may have any number of delineated areas greater than four as long as it is an even number and the areas are arranged in a symmetrical pattern. The provision of four areas as described above allows a label with two relatively foldable regions to be formed such that printed data may be concealed therebetween and consequently protected from degradation. The use of more areas, for example six areas forming a label with three regions, can in certain circumstances produce a label with advantageous properties for a particular application. In a label with three regions, one region might be folded against an adjacent region, and both those regions then be folded to lie against the remaining region. Such an arrangement allows a larger concealed area and therefore can be used to protect a greater amount of information on a label with a similar overall size.

The label once formed will preferably be provided with means for attachment to a particular item. The particular format of such attachment means can be varied according to the end purpose. However, it is preferred that they take the form of a cut or aperture in one region, which is formed by matching cuts or apertures in the areas that fold to form that region.

As discussed below, a particular application of the present invention is the formation of a tag attachable to a key ring for carrying personal data, and therefore it is preferred that the attachment means take the form of an aperture through which such a key ring can be connected.

The regions of the label are, as mentioned above, relatively folded to conceal information on the inwardly directed faces. To ensure that except when such information is required, the printed information is suitably protected and concealed, it is preferred that some mechanism be provided to selectively hold the regions in a folded state. This could be achieved by provision of a suitably configured fold line that resists unfolding, but it is advantageous that a catch arrangement be provided to hold the free edge together. One region may be provided with a tongue formed by a cut therethrough such that the edge or edges of other regions may be located therebehind to hold those regions in a position folded against that one region.

A particular application of the present invention is for carrying personal data that may occasionally be required. In particular, such data may take the form of mechanically readable information such as a barcode, wherein the integrity of that information must be maintained to ensure that mechanical reading is not impaired. One particular envisaged application would see the blank being formed into a label carrying mechanically-readable information identifying the bearer. Such information, probably in the form of a barcode, could be used in a supermarket or other store to identify a customer for the purposes of loyalty schemes. Of course the blank can be provided with any form of mechanically-readable information, such as a remotely readable microchip. It is commonplace for people to carry loyalty cards having some form of mechanically-readable identifying code, for example a magnetic strip or smart card, but it is not unusual for such items not to be present on all shopping occasions or for not all members of a family to possess a card. It is therefore envisaged that a label formed from a blank according to the present invention could be provided for attachment to the key ring of a loyalty card carrier such that should the loyalty card be unavailable, the machine-readable information on the tag might still be available to ensure that purchase is recorded.

A further use of a mechanically-readable blank is in situations where a person needs to be identified or tagged for security reasons, such as identifying a security guard or prisoner.

For these applications, it is highly advantageous that the tag may be printed as a self-adhesive blank and constructed into a label by a person peeling the blank therefrom. In this way one or more blanks may be attached to (and printed with) a letter with which the loyalty card is sent to the person, without the necessity for careful matching between the customer's details and the loyalty card reference number.

The self-adhesive sheet may be formed from suitable paper but preferably is formed from suitable printable plastics material as this is more durable.

According to the present invention there is also provided a printed label formed from a blank as previously discussed.

In order that it may be better understood, but by way of example only, four embodiments of the present invention will now be discussed in detail with reference to the accompanying drawings in which:

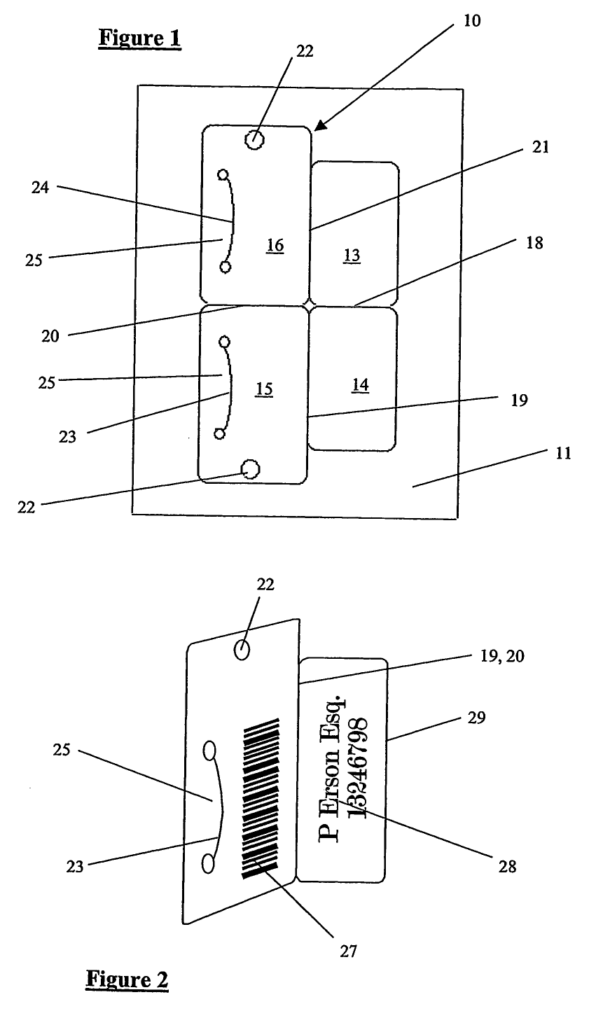

FIG. 1 is a first embodiment of blank having four areas;

FIG. 2 is a perspective view of a label folded from the first embodiment of blank;

FIG. 3 is a perspective view similar to FIG. 2 but showing the label in a fully folded configuration;

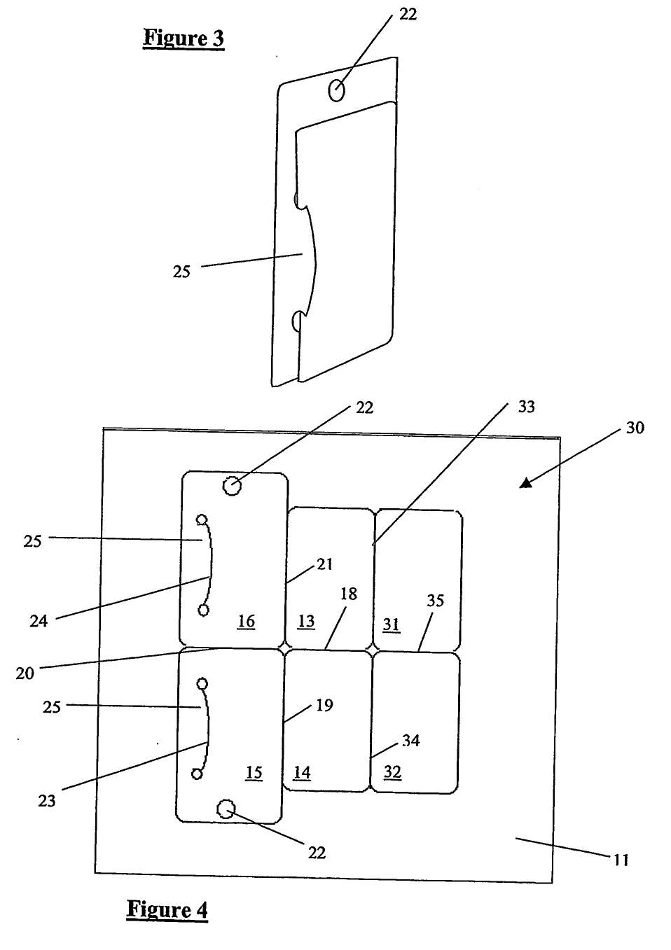

FIG. 4 is a second embodiment of blank having six areas;

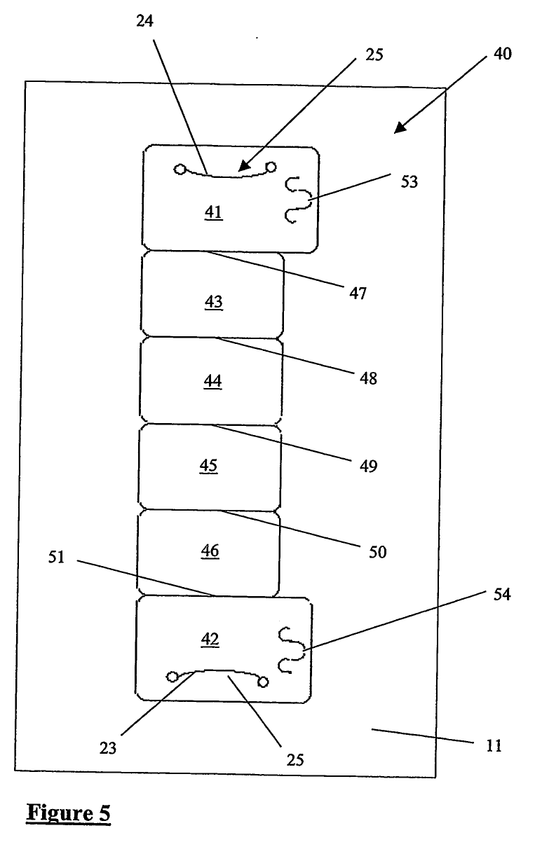

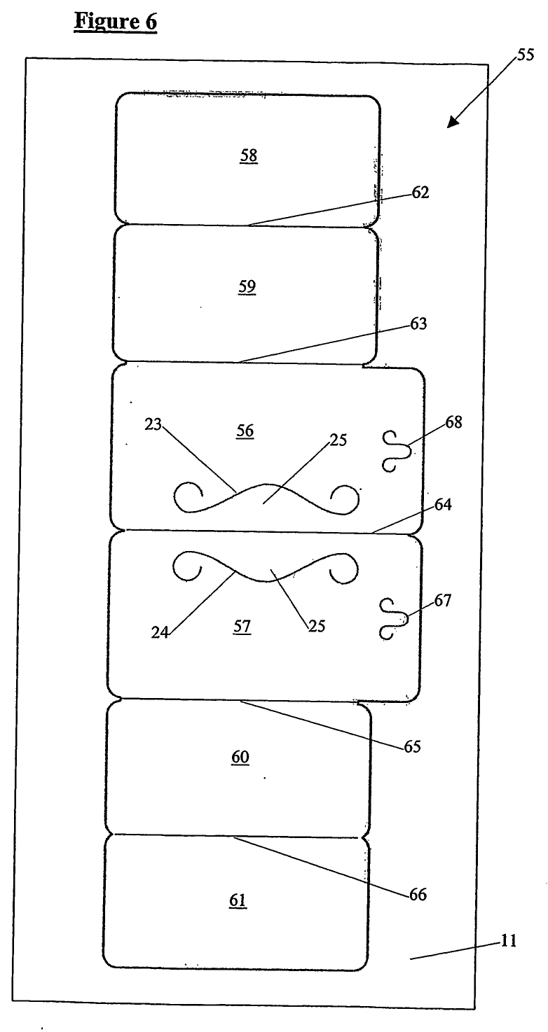

FIG. 5 is a third embodiment of blank also having six areas but in a linear configuration; and

FIG. 6 is a fourth embodiment of blank also having six areas in a linear configuration, but in a different order.

Referring initially to FIG. 1 there is shown a first embodiment of the present invention. The blank comprises a self-adhesive sheet generally indicated 10 which is on a strippable backing layer 11. The sheet 10 comprises four areas 13, 14, 15 and 16 that are joined along fold lines 18, 19, 20 and 21. Two of the areas, 13 and 14 are of a smaller size than the other areas 15 and 16.

Information may be printed upon the upper surface of each area 13, 14, 15 and 16, but information which is to be concealed by the folding of the areas is printed on those areas which will end up in face-to-face orientation. Once printed, the sheet 10 is stripped from the backing layer 11 and is folded along the line of symmetry that corresponds with fold lines 18 and 20. This brings the self-adhesive rear faces of the areas into contact (the rear face of area 13 contacting the rear face of area 14 and the rear face of area 15 contacting the matching rear face of area 16) such that they attach to each other. The resultant label has two regions, one larger one formed by the overlap of areas 15 and 16, and one smaller one formed by the overlap of areas 13 and 14. These two regions are separated by a fold line formed by the overlap of fold lines 19 and 21 and the regions may be relatively folded such that one lies against the other.

The larger of the two regions, formed from areas 15 and 16, is provided with an aperture 22 that permits attachment of the label to a key ring or other item. Formed in areas 15 and 16 are matching incisions 23 and 24 which in the resultant region form a slit that defines a tongue 25. The outer edge of the smaller region (formed from areas 13 and 14) will locate behind the tongue 25 to hold the regions in their overlying folded configuration. The relevant data is printed on the faces of the label that are concealed by this folding of the regions.

FIGS. 2 and 3 show the embodiment of blank of FIG. 1 in various stages of folding. In FIG. 2 the blank has been folded along fold lines 18 and 20 to form a label with two regions. The regions are hingedly joined along a fold line formed from fold lines 19 and 21 and the faces of these regions are provided with printed data. The data on the larger region in this example takes the form of a barcode 27, although an alternative machine-readable format could be used, and more readily decipherable information 28 is provided on the other region perhaps in the form of a bearers name and numerical code.

This printed data 27, 28 is concealed by the folding of the smaller region against the larger region as shown in FIG. 3. The free edge 29 of the smaller region locates behind the tongue 25 formed in the larger region to thereby hold the regions against one another. When access to the data 27 and 28 is required, the smaller region may be temporarily opened by removal of its outer edge 29 from beneath the tongue 25 and hinging along the fold line 19, 21.

FIG. 4 shows an alternative second embodiment that is similar to FIG. 1 but which has six regions rather than four. Similar numbering will be used to describe parts in FIG. 2 where there is comparison with FIG. 1. The embodiment in FIG. 2, generally indicated 30, has six areas, 13, 14, 15, 16 (which are the same as described with reference to FIG. 1) and two further areas 31 and 32 connected to the outer edge of areas 13 and 14 along fold lines 33 and 34, and connected to each other along fold line 35. When the blank is stripped from the backing layer 11 it is folded along the line of symmetry corresponding to fold lines 18, 20 and 35, to form a label with three regions. The outer region formed by the overlap of areas 31 and 32 is first folded to lie against the middle region formed from areas 13 and 14 by hinging along the fold line formed from coincident fold lines 33 and 34. These two regions are then folded in the same direction about coincident fold lines 19, 21 to lie against the larger region (formed from areas 15 and 16) with the outer region sandwiched between the larger region and the middle region. The edge formed by relative folding of the outer and middle regions, along fold lines 33 and 34 will locate behind the tongue 25 to hold the outer and middle regions against the larger region in a similar way to that described in relation to the first embodiment.

FIG. 5 shows a third embodiment that has some similarity to the second embodiment described above. However, in this third embodiment the blank generally indicated 40 has six areas formed in a linear arrangement. The six areas comprise two larger areas 41 and 42 at the ends, with four smaller areas 43, 44, 45 and 46 disposed therebetween. The areas are delineated by fold lines 47, 48, 49, 50 and 51. When peeled from the backing layer 11, the blank is first folded along fold line 49 such that the larger areas 41 and 42, the smaller areas 43 and 46, and the other smaller areas 44 and 45 each come into contact and their adhesive faces hold them together to thereby form a three regioned label similar to that described in FIG. 4. Subsequent to this the further folding and use of this third embodiment of label is essentially the same as described above with reference to the second embodiment. One slight further difference in structure between the two is that in this third embodiment the mechanism for permitting attachment to a key ring, or other item, comprises matching slits 53 and 54 in the larger areas 41 and 42 which co-operate to form a slit in the larger region through which a part of the item to which the label is to be attached may be passed.

FIG. 6 shows a fourth embodiment that has some similarity to the second and third embodiments described above. In this fourth embodiment the blank generally indicated 55 has six areas formed in a linear arrangement, but in comparison to the second embodiment the areas are in a different order. The six areas comprise two larger areas 56 and 57 positioned in the middle, with four smaller areas 58, 59, 60 and 61 disposed on the ends. The areas are delineated by fold lines 62, 63, 64, 65 and 66. When peeled from the backing layer 11, the blank is first folded along fold line 64 such that the larger areas 56 and 57, the smaller areas 58 and 61, and the other smaller areas 59 and 60 each come into contact and their adhesive faces hold them together to thereby form a three regioned label similar to that described in FIGS. 4 and 5. Subsequent to this the further folding and use of this fourth embodiment of label is essentially the same as described above with reference to the third embodiment, whereby matching slits 67 and 68 in the larger areas 56 and 57 co-operate to form a slit in the larger region through which a part of an item to be attached may be passed.

Clearly other more complicated variants of the present invention could be provided by design of blanks with different arrangements of areas, and these fall within the scope of this invention. They must of course provide means for concealing and thereby protecting information printed thereon but could have varying mechanisms for folding and attachment.

1. A blank for forming into a label for carrying information, which blank comprises a self adhesive sheet having delineated thereon at least four distinct areas in a symmetrical arrangement with a strippable backing layer on the self-adhesive face of the blank, each area having an upper surface on which data can be mechanically printed and there being fold lines between adjacent areas whereby on stripping the printed blank from the backing layer and folding the blank about a fold line coincident with the axis of symmetry the self-adhesive faces are brought into contact with each other thereby forming a label having half as many regions as there were areas in the blank, those regions being separated by overlying fold lines about which the regions may be relatively folded to conceal printed information thereon.

2. A blank as claimed in claim 1, wherein the blank has six areas that fold to form a label with three regions.

3. A blank as claimed in claim 1, in which there are three or more regions in the label and these are folded such that they overlie each other.

4. A blank as claimed in claim 1, wherein at least one region is provided with means for attachment of the label to an item.

5. A blank as claimed in claim 4, wherein the means for attachment comprises a cut or aperture formed in one region of the label by matching cut lines or apertures in the areas of the sheet that fold to form that region.

6. A blank as claimed in claim 1, wherein there is provided a catch arrangement for releasably holding the regions in a relatively folded configuration.

7. A blank as claimed in claim 6, wherein the catch arrangement includes a tongue formed in one region such that the edge or edges of other region or regions may be located therebehind to hold that region or regions in a position folded against the one region.

8. A blank as claimed in claim 1, wherein the concealed printed information includes a barcode or other machine readable information.

9. A blank as claimed in claim 1, wherein a machine readable microchip is attached to the self adhesive sheet.

10. A blank as claimed in claim 1, wherein the label is adapted for connection to a key ring.

11. A printed label formed from a blank as claimed in claim 1.
